(19) United States
(12) Patent Application Publication
(10) Pub. No.: US 2006/0272440 A1
(43) Pub. Date: Dec. 7, 2006

(54) Shifting mechanism, and shifting mechanism-mounted image capturing apparatus

(75) Inventors: Hiroyuki Mori, Kanagawa (JP); Tatsuo Makii, Tokyo (JP); Keisuke Ikegami, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation

(21) Appl. No.: 11/447,146

(22) Filed: Jun. 6, 2006

(30) Foreign Application Priority Data
Jun. 6, 2005 (JP) 2005-177730

(51) Int. Cl. B60K 17/04

(52) U.S. Cl. 74/473.12

(57) ABSTRACT

There is provided a shifting mechanism involving use of a linear actuator having a driving magnet and a driving coil as drive means for shifting a driven unit, or a movable lens contained in the driven unit, or an imaging device in a prescribed direction, which includes a piezoelectric device deformable with a drive voltage applied thereto and adapted to control shifting of the driven unit at the time when the piezoelectric device is deformed. There is also provided an image capturing apparatus having the shifting mechanism.

### CROSS REFERENCES TO RELATED APPLICATIONS

The present document contains subject matter related to Japanese Patent Application JP 2005-177730 filed in the Japanese Patent Office on Jun. 17, 2005, the entire contents of which being incorporated herein by reference.

### BACKGROUND OF THE INVENTION

1. Field of the Invention

The present invention relates to a technical field of a shifting mechanism, and an image capturing apparatus having the shifting mechanism mounted therein. More specifically, the present invention relates to a technical field that is intended to attain power saving etc. by taking advantage of deformation of a piezoelectric device to control shifting of a driven unit.

2. Description of Related Art

A linear actuator for shifting a driven unit, or a movable lens contained in the driven unit, or an imaging device in a prescribed direction is incorporated in various types of image capturing apparatuses of mobile phones etc., in addition to video cameras and still cameras. For instance, the movable lens forms the driven unit, together with a lens holder that holds the movable lens. The driven unit is shifted with the linear actuator in an optical axis direction for focusing or zooming, or in directions orthogonal to the optical axis direction for anti-shaking.

This type of linear actuator has a driving magnet and a driving coil, and is adapted to shift the driven unit in the prescribed direction by applying a drive force to the driven unit when a drive current is supplied to the driving coil (See Japanese Patent publication No. 3387173, for instance).

However, an image capturing apparatus having the above type of linear actuator as drive means for shifting the driven unit in the prescribed direction requires continuous energizing to the driving coil also at the time when the linear actuator shifts the driven unit in the prescribed direction and is followed by holding of the driven unit in the shifted position. Thus, this type of image capturing apparatus presents a problem that high consumption power is required in accordance with a need for the continuous energizing.

Further, the linear actuator shows no retentiveness to hold the driven unit in a required position at the time of non-energizing. Thus, when power to the image capturing apparatus is off, the linear actuator causes a poor condition that unnecessary shifting of the driven unit occurs, leading to generation of unusual noise by collisions etc. of the driven unit against an end where the unnecessary shifting is terminated.

### SUMMARY OF THE INVENTION

Accordingly, a shifting mechanism and an image capturing apparatus having the shifting mechanism mounted therein according to embodiments of the present invention have undertaken to overcome the above problems, and are intended to attain power saving etc.

In order to solve the above problems, a shifting mechanism and an image capturing apparatus having the shifting mechanism mounted therein according to embodiments of the present invention relate to a shifting mechanism or an image capturing apparatus involving use of a linear actuator having a driving magnet and a driving coil as drive means for shifting a driven unit, or a movable lens contained in the driven unit, or an imaging device in a prescribed direction. The shifting mechanism and the image capturing apparatus are provided with a piezoelectric device deformable with a drive voltage applied thereto and adapted to control shifting of the driven unit at the time when the piezoelectric device is deformed.

Thus, the shifting mechanism and the image capturing apparatus having the shifting mechanism according to the embodiments of the present invention allow a stopped state of the driven unit to be kept by deformation of the piezoelectric device, resulting in no need for energizing to the linear actuator while the driven unit is in the stopped state.

Thus, the shifting mechanism according to the embodiment of the present invention having the above-described structure enables holding of the driven unit in prescribed position to be performed in a state where energizing to the linear actuator is stopped and no continuous energizing to the piezoelectric device is required, permitting a reduction in consumption power to be attained.

According to another embodiment of the shifting mechanism of the present invention, the driven unit may be shifted in mutually perpendicular first and second directions respectively orthogonal to an optical axis direction of an optical imaging system including the movable lens and the imaging device, and is provided with a first piezoelectric device adapted to control shifting of the driven unit in the first direction, and a second piezoelectric device adapted to control shifting of the driven unit in the second direction. Thus, this type of shifting mechanism according to the embodiment of the present invention also enables holding of the driven unit in prescribed position to be performed in the state where energizing to the linear actuator is stopped and no continuous energizing to the first and the second piezoelectric devices is required, permitting the reduction in consumption power to be attained.

According to still another embodiment of the shifting mechanism of the present invention, the piezoelectric device may have one end in the form of a fixed end, and the other end in the form of a free end, and contact of the free end with the driven unit is made to control the shifting of the driven unit at the time when the piezoelectric device is deformed. Thus, this type of shifting mechanism according to the embodiment of the present invention avoids any possibility that the piezoelectric device is shifted with the shifting of the driven unit, permitting electric wire arrangement works for energizing to the piezoelectric device and installation of the piezoelectric device to be made more easily.

According to still another embodiment of the shifting mechanism of the present invention, the shifting mechanism may have deformation scale-up means for increasing an extent of deformation of the piezoelectric device. In the shifting mechanism, the piezoelectric device is placed at one end side of the deformation scale-up means, and contact of the other end of the deformation scale-up means with the driven unit is made to control the shifting of the driven unit at the time when the piezoelectric device is deformed. Thus, this type of shifting mechanism according to the embodiment of the present invention may employ a piezoelectric device limited in deformation to a small extent, permitting reductions in size and manufacture cost of the shifting mechanism to be attained in accordance with use of the piezoelectric device limited in deformation.

According to further another embodiment of the shifting mechanism of the present invention, the shifting mechanism has an energizing spring that applies an energizing force to the piezoelectric device in a direction to remove limitation on the shifting of the driven unit. Thus, this type of shifting mechanism according to the embodiment of the present invention may eliminate unnecessary shifting of the deformation scale-up means.

Thus, the image capturing apparatus having shifting mechanism mounted therein according to the embodiment of the present invention having the above-described structure enables holding of the driven unit in prescribed position to be performed in the state where energizing to the linear actuator is stopped and no continuous energizing to the piezoelectric device is required, permitting the reduction in consumption power

### BRIEF DESCRIPTION OF THE DRAWINGS

The above and other objects, features and advantages of the present invention will become more apparent from the following description of presently preferred exemplary embodiments of the invention taken in conjunction with the accompanying drawings, in which:

FIG. 1 is a block diagram showing an overall configuration of an image capturing apparatus;

FIG. 2 is a side view, partly in section, showing a state where no control is given to shifting of a driven unit;

FIG. 3 is a side view, partly in section, showing a state where the shifting of the driven unit is under control;

FIG. 4 is an enlarged side view, partly in section, showing the state where no control is given to the driven unit, in relation to a shifting mechanism according to one embodiment in which contraction of a piezoelectric device causes the driven unit to be shifted;

FIG. 5 is an enlarged side view, partly in section, showing a state where the shifting of the driven unit is under control, in relation to the shifting mechanism shown in FIG. 4;

FIG. 6 is a side view, partly in section, showing a state where no control is given to the driven unit, in relation to a shifting mechanism according to a first modification;

FIG. 7 is a side view, partly in section, showing a state where no control is given to the driven unit, in relation to a shifting mechanism according to a second modification;

FIG. 8 is a side view, partly in section, showing a state where the shifting of the driven unit is under control, in relation to the shifting mechanism shown in FIG. 7;

FIG. 9 is a side view, partly in section, showing a state where no control is given to the driven unit, in relation to a shifting mechanism according to a third modification;

FIG. 10 is a side view,.partly in section, showing a state where the shifting of the driven unit is under control, in relation to the shifting mechanism shown in FIG. 9;

FIG. 11 is an enlarged front view showing one application of the present invention to an anti-shake mechanism; and

FIG. 12 is a schematic view showing one manner of controlling shifting of an imaging device.

### DETAILED DESCRIPTION OF EMBODIMENTS

An image capturing apparatus according to the present invention is applicable to various types of image capturing apparatuses having a moving or still image capturing function, such as mobile phones, video cameras and still cameras. A shifting mechanism according to the present invention is applicable to various types of shifting mechanisms incorporated in these types of image capturing apparatuses.

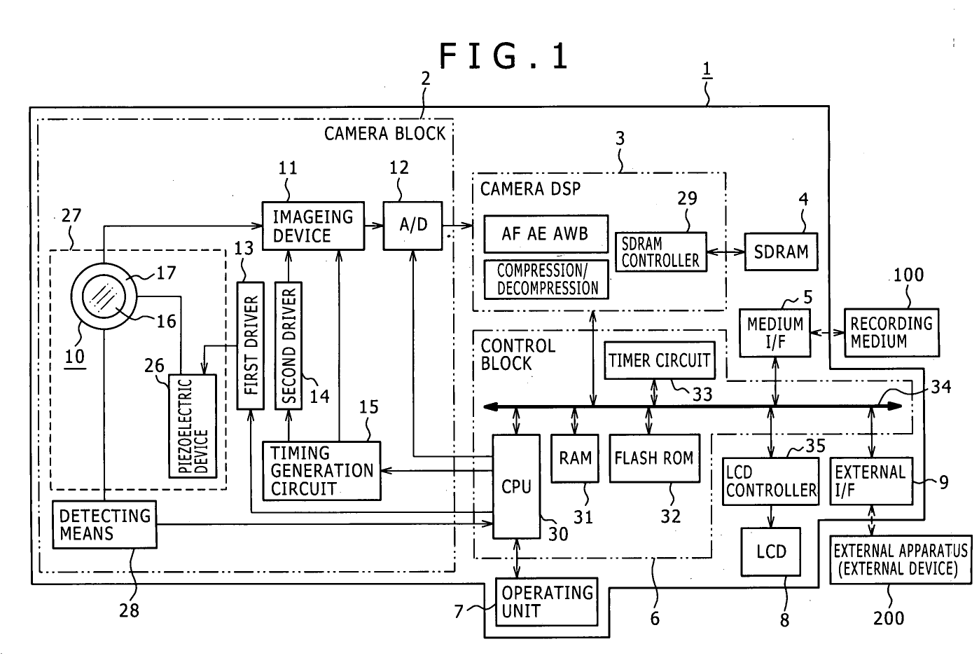

As shown in FIG. 1, an image capturing apparatus 1 has a camera block 2, a camera digital signal processor (DSP) 3, a synchronous dynamic random access memory (SDRAM) 4, a medium interface 5, a control block 6, an operating unit 7, a liquid crystal display (LCD) 8, and an external interface 9. The image capturing apparatus 1 permits detachable mounting of a recording medium 100 to the image capturing apparatus.

The recording medium 100 is available in various types of recording mediums including a so-called memory card involving use of a semiconductor memory, and a disk-shaped recording medium such as a recordable digital versatile disc (DVD) and a recordable Compact Disc (CD).

The camera block 2 has a driven unit 10, an imaging device 11 such as a charge coupled device (CCD), an A/D conversion circuit 12, a first driver 13, a second driver 14 and a timing generation circuit 15, etc.

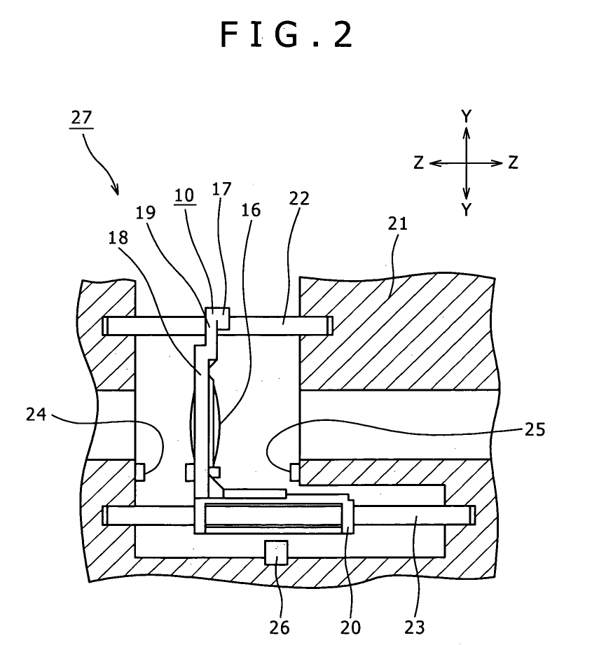

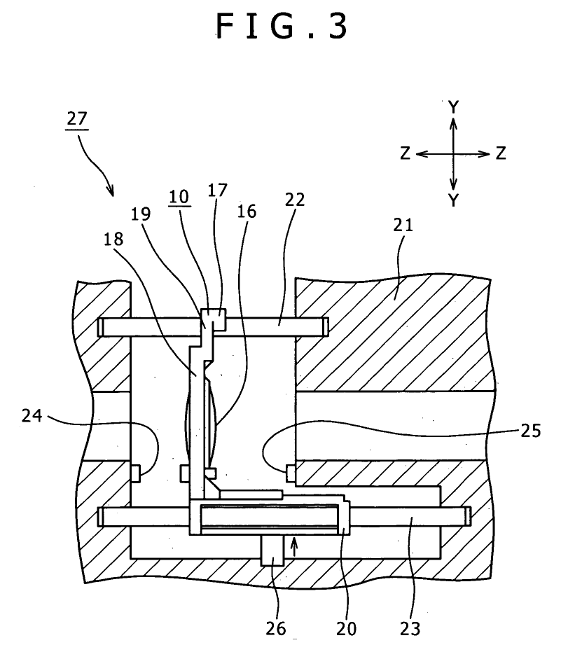

As shown in FIGS. 2 and 3, the driven unit 10 has a movable lens 16 to be shifted in an optical axis direction (i.e., Z-direction shown in FIGS. 2 and 3) for focusing or zooming, and a lens holder 17 that holds the movable lens 16, for instance. The driven unit 10 is shifted with a drive force given from a non-illustrated linear actuator having a driving magnet and a driving coil.

The lens holder 17 is formed with an approximately annular-shaped lens holder body 18 that holds the movable lens 16, and first and second supported projections 19 and 20 made projecting from a side face of the lens holder body 18 in directions opposite to each other. The second supported projection 20 is in an approximately cylindrical form extending in the optical axis direction.

The driven unit 10 is supported within a lens barrel 21 movably in the optical axis direction.

The lens barrel 21 has, at its inside, guide shafts 22 and 23 both extending in the optical axis direction. The guide shaft 22 is inserted into the first supported projection 19 of the lens holder 17, while the guide shaft 23 is inserted into the second supported projection 20 of the lens holder 17. Thus, the driven unit 10 is supported with the guide shafts 22 and 23 movably.

It is to be noted that support means required for the driven unit 10 is not limited to the above guide shafts 22 and 23, and it is also allowable to provide the lens barrel 21 having a guide groove or a guide projection for use as the support means.

An inside face of the lens barrel 21 is fitted with rearward- or forward-directional stopper projections 24 and 25. The driven unit 10 is adaptable to be shifted in the optical axis direction up to a position being contact with either stopper projection 24 or 25 will be made.

A piezoelectric device 26 is placed on the inside face of the lens barrel 21, specifically, at its lower and, for instance. The piezoelectric device 26 is formed lengthwise in one direction, i.e., Y-direction (See FIGS. 2 and 3) orthogonal to the optical axis direction, or, a direction orthogonal to a direction of shifting of the driven unit 10, and has a lower end in the form of a fixed end that permits the piezoelectric device to be secured to the lens barrel 21. The piezoelectric device 26 is located with its top end face facing and close to the second supported projection 20 of the lens holder 17 (See FIG. 2).

The piezoelectric device 26 has a longitudinally multi-layered configuration formed of a large number of piezoelectric porcelain sheets composed of zircon lead titanate and having electrodes fitted to their respective opposite faces, in which case, the electrodes are connected to each other in parallel. The piezoelectric device 26 is expanded in a multi-layer direction (a longitudinal direction) by application of a drive voltage thereto, and its expanded state may be kept for a certain period of time with the drive voltage application stopped. On the other hand, application of a reverse drive voltage to the piezoelectric device 26 causes the piezoelectric device to be contracted in the multi-layer direction (the longitudinal direction).

The driven unit 10, the linear actuator provided as the drive means, the guide shafts 22 and 23 and the piezoelectric device 26 are all specified as components of a shifting mechanism 27.

As shown in FIG. 1, the imaging device 11 operates in response to a drive signal sent from the second driver 14 to capture an object image obtained by capturing through the movable lens 16, and then sends the captured object image (image information) in the form of an electric signal to the A/D conversion circuit 12 based on a timing signal outputted from the timing generation circuit 15 controlled by the control block 6.

It is to be noted that the imaging device 11 is not limited to the CCD, and it is also allowable to use, as the imaging device 11, other types of devices such as a complementary metal-oxide semiconductor (CMOS).

The A/D conversion circuit 12 is effective in holding a satisfactory S/N ratio resulting from execution of a correlated double sampling (CDS) processing to the received image information in the form of the electric signal, in controlling a gain resulting from execution of an automatic gain control (AGC) processing to the above image information, in generating image data in the form of a digital signal resulting from execution of analog/digital (A/D) conversion to the above image information, and the like.

The first driver 13 sends a drive signal to the piezoelectric device 26 on the basis of a command from a later described CPU in the control block 6.

The second driver 14 sends the drive signal to the imaging device. 11 on the basis of the timing signal from the timing generation circuit 15.

The timing generation circuit 15 generates, depending on control by the control block 6, a timing signal that provides a prescribed timing.

The camera block 2 has detecting means 28 of detecting a distance of shift of the driven unit 10 in the optical axis direction. The detecting means 28 is available in various types of detecting means including a magnetic detecting means such as a magneto resistance (MR) sensor and an optical detecting means having a hall element etc., for instance. A detection result obtained with the detecting means 28 is supplied as position information of the driven unit 10 to the later described CPU in the control block 6.

The camera DSP 3 gives signal processing such as auto focus (AF), auto exposure (AE), and auto white balance (AWB) to the image data received from the A/D conversion circuit 12. The image data having undergone the signal processing such as AF, AE and AWB is given data compression in a prescribed fashion, before being outputted to the recording medium 100 through the control block 6 for recording of the image data in the form of a file onto the recording medium 100.

The camera DSP 3 has a SDRAM controller 29, in which case, reading and writing of data with respect to the SDRAM 4 may be performed at high speed according to a command from the SDRAM controller 29.

The control block 6 is a microcomputer having a configuration obtained by interconnection of various units such as a central processing unit (CPU) 30, a random access memory (RAM) 31, a flash read only memory (ROM) 32, and a timer circuit 33 through a system bus 34. The control block 6 provides a function of controlling each unit of the image capturing apparatus 1.

The CPU 30 sends a command signal to the first driver 13 and to the second driver 14 etc. through the timing generation circuit 15 to bring these units into operation. To the CPU 31 is supplied the position information of the driven unit 10 as the detection result obtained with the detecting means 28, and the CPU 30 causes output of the command signal to the first driver 13 based on the received position information.

The RAM 31 is mainly used as a working area for temporary storage etc. of partially completed results of processing.

Various types of programs executed in the CPU 30 and data etc. required for each processing are stored in the flash ROM 32.

The timer circuit 33 is a circuit that outputs information such as a present-date, a present day of the week, a present time and an image capturing date.

The operating unit 7 includes a touch panel and a control key etc. that are provided on a non-illustrated casing (an outer casing) of the image capturing apparatus 1. A signal suitable for an operation given to the operating unit 7 is supplied to the CPU 30, and the CPU 30 sends the command signal to each unit on the basis of the received signal.

The LCD 8 is provided on the casing, for instance, and is controlled by a LCD controller 35 connected to the system bus 34. The LCD 8 displays various types of information such as image data obtained based on a drive signal from the LCD controller 35.

The external interface 9 is connected to the system bus 34. Connection to an external apparatus 200 such as an external personal computer through the external interface 9 makes it possible to receive image data from the external personal computer for recording of the received image data onto the recording medium 100 or to output image data contained in the recording medium 100 to the external personal computer etc. It is to be noted that the recording medium 100 is connected to the control block 6 through the medium interface 5 connected to the system bus 34.

Further, connection to a network such as the Internet by connecting an external device 200 such as a communication module to the external interface 9 makes it possible to acquire various types of image data and other information through the network for recording of these data and information onto the recording medium 100 or to transmit data contained in the recording medium 100 to an aimed destination through the network.

It is to be noted that the external interface 9 may be installed in the form of a wire interface such as Institute of Electrical and Electronics Engineers (IEEE) 1394 and universal serial bus (USB), or alternatively, a wireless interface involving use of light and electric waves.

Meanwhile, the image data contained in the recording medium 100 is sent to the camera DSP 3 through the medium interface 5, after being read out from the recording medium 100 on the basis of the operation signal in response to the operation given to the operating unit 7 by a user.

The camera DSP 3 decompresses the image data received in a compressed form after being read out from the recording medium 100, and then sends the decompressed image data to the LCD controller 35 through the system bus 34. The LCD controller 35 sends the image signal based on the decompressed image data to the LCD 8.. Thus, the LCD 8 may give the display of an image based on the image signal.

In the image capturing apparatus 1 having the above configuration, when the drive current is supplied to the driving coil of the linear actuator, the driven unit 10 may be shifted in the optical axis direction (backward and forward) depending on a supplied drive current direction.

When the driven unit 10 reaches a predetermined position, the first driver 13 applies the drive voltage to the piezoelectric device 26 on the basis of the drive signal sent from the CPU 30 according to the detection result obtained with the detecting means 28, causing the piezoelectric device 26 to be expanded (See FIG. 3). With the piezoelectric device 26 expanded, a top end face of the piezoelectric device 26 is pressed into contact with the second supported projection 20 of the lens holder 17, causing the shifting of the driven unit 10 to be stopped.

At the same time as the application of the drive voltage from the first driver 13 to the piezoelectric device 26, supply of the drive current to the driving coil of the linear actuator is stopped.

When the piezoelectric device 26 causes the shifting of the driven unit 10 to be stopped, the application of the drive voltage to the piezoelectric device 26 is stopped. The piezoelectric device 26 is allowed to keep its expanded state for a certain period of time even after the application of the drive voltage to the piezoelectric device 26 is stopped, so that a stopped state of the driven unit 10 may be kept. Although the piezoelectric device 26 ensures that its expanded state is kept for a certain period of time, it is to be noted that application of a minimum drive voltage adaptable to keep the expanded state of the piezoelectric device 26 to the piezoelectric device 26 is also allowable depending on a time to keep the stopped state of the driven unit 10. At this time, consumption power is lower than that required for keeping the stopped state of the driven unit by energizing to the linear actuator.

When the drive current is re-supplied to the driving coil of the linear actuator, the first driver 13 applies, to the piezoelectric device 26, a reverse drive voltage different in direction from the last applied drive voltage.

When the first driver 13 applies the reverse drive voltage to the piezoelectric device 26, the piezoelectric device 26 becomes contracted away from the second supported projection 20 of the driven unit 10, causing a holding state against the driven unit 10 to be released. Accordingly, re-supply of the drive current to the driving coil leads to the shifting of the driven unit 10 in the optical axis direction.

Sequentially, the application of the reverse drive voltage to the piezoelectric device 26 is stopped, in which case, however, the piezoelectric device 26 is allowed to keep its contracted state.

As described above, the shifting mechanism 27 enables holding of the driven unit 10 in a prescribed position to be performed in a state where energizing to the linear actuator is stopped and no continuous energizing to the piezoelectric device 26 is required, permitting a reduction in consumption power to be attained.

Further, the shifting mechanism 27 allows the driven unit 10 to be held in the prescribed position with the piezoelectric device 26 kept deformed (the expanded state), and thus may eliminate any possibility that unnecessary shifting of the driven unit 10 occurs, even when power to the image capturing apparatus 1 is off, leading to no collision of the driven unit 10 against the stopper projections 24 and 25, and thus permitting prevention of unusual noise generation.

Furthermore, the shifting mechanism 27 ensures that the piezoelectric device 26 is secured to the lens barrel 21, and thus may eliminate any possibility-that the piezoelectric device 26 is shifted with the shifting of the driven unit 10, permitting electric wire arrangement works for energizing to the piezoelectric device 26 and installation of the piezoelectric device 26 to be made more easily.

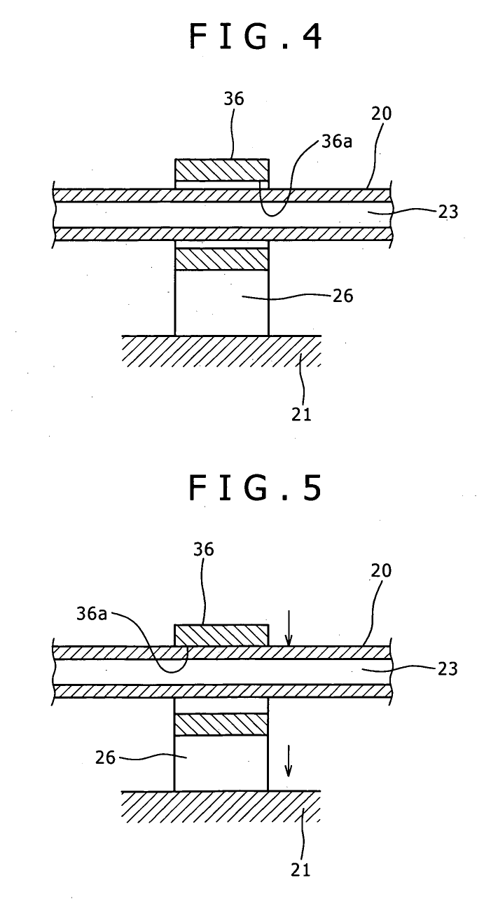

The above embodiment has been described in relation to the shifting mechanism of a type that is adapted to hold the driven unit 10 in position by controlling the shifting of this driven unit when the piezoelectric device 26 is in the expanded state. On the contrary, it is also allowable to hold the driven unit 10 in position by controlling the shifting of this driven unit when the piezoelectric device 26 is in the contracted state, as described in the following (See FIGS. 4 and 5).

An upper face of the piezoelectric device 26 is fitted with a regulating member 36 made of a rubber or resin material, for instance. The regulating member 36 has an insertion hole 36a, and the second supported projection 20 of the driven unit 10 is inserted into the insertion hole 36a. With no control given to the shifting of the driven unit 10 yet, the regulating member 36 is out of contact with the second supported projection 20 (See FIG. 4).

When the drive voltage is applied to the piezoelectric device 26, the piezoelectric device 26 is contracted into pressure contact of an inside face of the regulating member 36 with the second supported projection 20, causing the shifting of the driven unit 10 to be controlled (See FIG. 5).

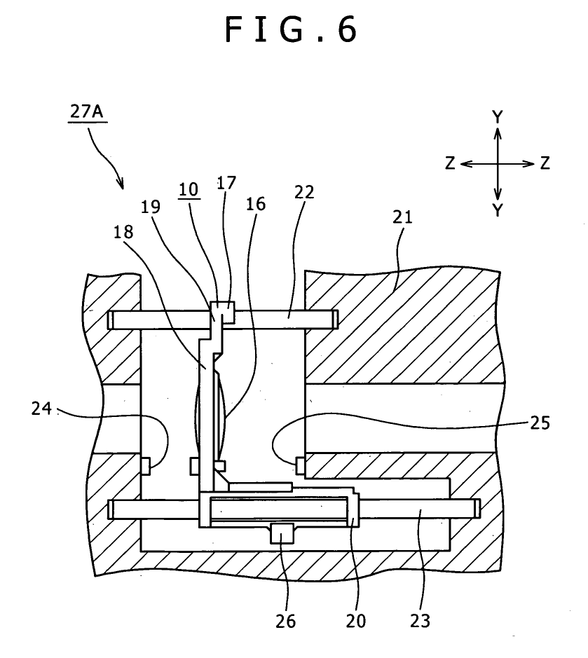

Various types of modifications of the shifting mechanism are described in the following (See FIGS. 6 to 10).

First of all, a shifting mechanism 27A according to a first modification is described (See FIG.. 6). The shifting mechanism 27A according to the first modification is similar to the above shifting mechanism 27 only except that the piezoelectric device 26 expandable and contractile in the multi-layer direction is fitted to the driven unit 10. Thus, different portions as compared with the above shifting mechanism 27 are only described in detail, and other portions are given the same reference numerals used for similar portions in the above shifting mechanism 27, and are not described.

The piezoelectric device 26 is fitted, for instance, to the second supported projection 20 of the driven unit 10, and is made projecting downwards from the second supported projection 20.

In the shifting mechanism 27A, when the drive current is supplied to the driving coil of the linear actuator, the driven unit 10 may be shifted in the optical axis direction depending on the supplied drive current direction.

When the driven unit 10 reaches the prescribed position, the drive voltage is applied to the piezoelectric device 26, causing the piezoelectric device 26 to be expanded into pressure contact with the inside face of the lens barrel 21, thus causing the shifting of the driven unit 10 to be stopped.

At the same time as the application of the drive voltage to the piezoelectric device 26, the supply of the drive current to the driving coil of the linear actuator is stopped.

When the piezoelectric device 26 causes the shifting of the driven unit 10 to be stopped, the application of the drive voltage to the piezoelectric device 26 is stopped. The piezoelectric device 26 is allowed to keep its expanded state even after the application of the drive voltage to the piezoelectric device 26 is stopped, so that the stopped state of the driven unit 10 may be kept.

When the drive current is re-supplied to the driving coil of the linear actuator, the reverse drive voltage different in direction from the last applied drive voltage is applied to the piezoelectric device 26, causing the piezoelectric device 26 to be contracted away from the inside face of the lens barrel 21, thus causing the holding state against the driven unit 10 to be released. Accordingly, the re-supply of the drive current to the driving coil leads to the shifting of the driven unit 10 in the optical axis direction.

Sequentially, the application of the reverse drive voltage to the piezoelectric device 26 is stopped, in which case, however, the piezoelectric device 26 is allowed to keep its contracted state.

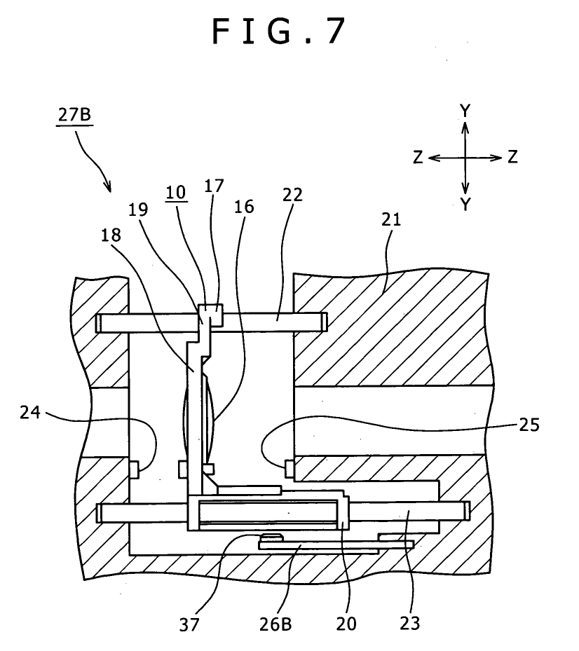

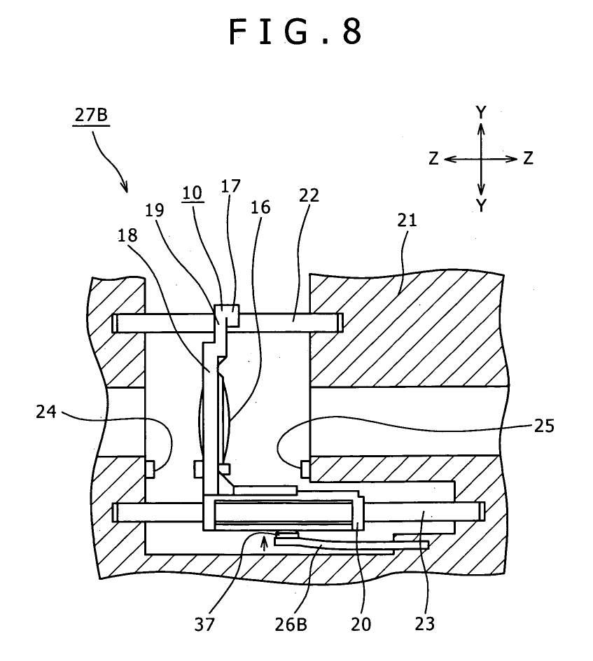

Next, a shifting mechanism 27B according to a second modification is described (See FIGS. 7 and 8). The shifting mechanism 27B according to the second modification is similar to the above shifting mechanism 27 only except that the shifting mechanism 27B involves use of a-piezoelectric device 26B deformed in a bent form in a direction orthogonal to the longitudinal direction, instead of the piezoelectric device 26 expandable and contractile in the multi-layer direction. Thus, different portions as compared with the above shifting mechanism 27 are only described in detail, and other portions are given the same reference numerals used for similar portions in the above shifting mechanism 27, and are not described.

The piezoelectric device 26B is available in two types, a so-called bimorph type having a configuration with a pair of devices (ceramic devices) bonded to the opposite faces of a metal sheet such as a steel sheet, and a so-called unimorph type having a configuration with the device (the ceramic device) bonded only to one face of the metal sheet.

The piezoelectric device 26B is formed lengthwise in the longitudinal direction (the same direction as the optical axis), and has a rear end, for instance, in the form of a fixed end that permits the piezoelectric device to be secured to the lens barrel 21, and a remaining portion excepting the rear end is placed at an underside of the second supported projection 20 of the driven unit 10 and slightly away from the lens barrel 21. The application of the drive voltage to the piezoelectric device 26B causes the piezoelectric device 26B to be deformed into the bent form such that a front end of the piezoelectric device 26B may be shifted upwards and downwards.

The front end of the piezoelectric device 26B is fitted with a depressing member 37 made of a rubber or resin material in an upwardly projecting position, for instance.

In the shifting mechanism 27B having the above configuration, when the drive current is supplied to the driving coil of the linear actuator, the driven unit 10 may be shifted in the optical axis direction depending on the supplied drive current direction.

When the driven unit 10 reaches the prescribed position, the first driver 13 applies the drive voltage to the piezoelectric device 26B based on the drive signal sent from the CPU 30 according to the detection result obtained with the detecting means 28, causing the piezoelectric device 26B to be deformed such that the front end of the piezoelectric device may be shifted nearer to the driven unit 10 (See FIG. 8). With the piezoelectric device 26B deformed, the depressing member 37 fitted to the front end of the piezoelectric device 26B is pressed into contact with the second supported projection 20 of the lens holder .17, causing the shifting of the driven unit 10 to be stopped.

At the same time as the application of the drive voltage from the first driver 13 to the piezoelectric device 26B, the supply of the drive current to the driving coil of the linear actuator is stopped.

When the piezoelectric device 26B causes the shifting of the driven unit 10 to be stopped, the application of the drive voltage to the piezoelectric device 26B is stopped. The piezoelectric device 26B is allowed to keep its deformed state for a certain period of time even after the application of the drive voltage to the piezoelectric device 26B is stopped, so that the stopped state of the driven unit 10 may be kept.

When the drive current is re-supplied to the driving coil of the linear actuator, the first driver 13 applies, to the piezoelectric device 26B, the reverse drive voltage different in direction from the last applied drive voltage.

When the first driver 13 applies the reverse drive voltage to the piezoelectric device 26B, the piezoelectric device 26B is restored to its original state to bring the depressing member 37 away from the second supported projection 10 of the driven unit 10, causing the holding state against the driven unit 10 to be released. Accordingly, the re-supply of the drive current to the driving coil leads to the shifting of the driven unit 10 in the optical axis direction.

Sequentially, the application of the reverse drive voltage to the piezoelectric device 26B is stopped, in which case, however, the piezoelectric device 26B is allowed to keep its original state.

Use of the piezoelectric device 26B that is deformed in the bent form in the direction orthogonal to the direction of shifting of the driven unit. 10 as described above enables the piezoelectric device 26B to be placed in a space between the inside face of the lens barrel 21 and the driven unit 10 and in parallel to the direction of shifting of the driven unit 10, permitting a desired extent of deformation of the piezoelectric device 26B to be ensured by setting a length of the piezoelectric device 26B as desired, while realizing space saving.

It is to be noted that instead of direct contact of the piezoelectric device 26B with the driven unit 10, contact of the rubber or resin material-made depressing member 37 with the driven unit 10 to control the shifting of the driven unit as described above makes it possible to absorb noise generated at the time when controlling the shifting, to prevent the driven unit 10 and the piezoelectric device 26B from being flawed or damaged, and also to reduce variations in control force with errors in installation of the driven unit 10 and the piezoelectric device 26B.

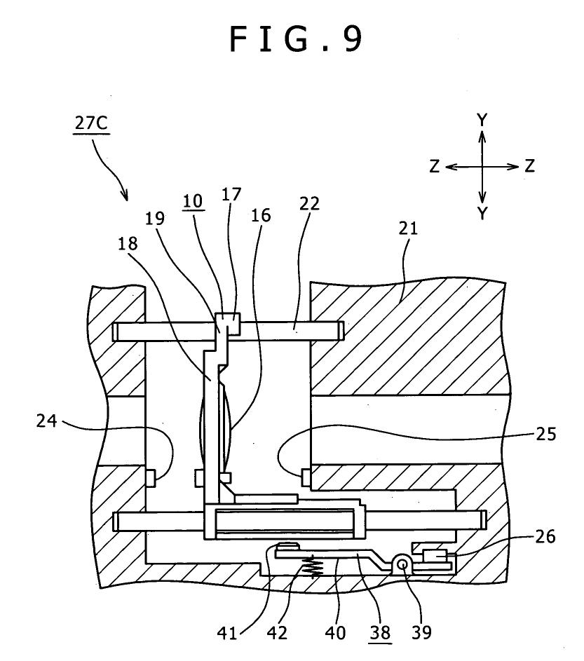

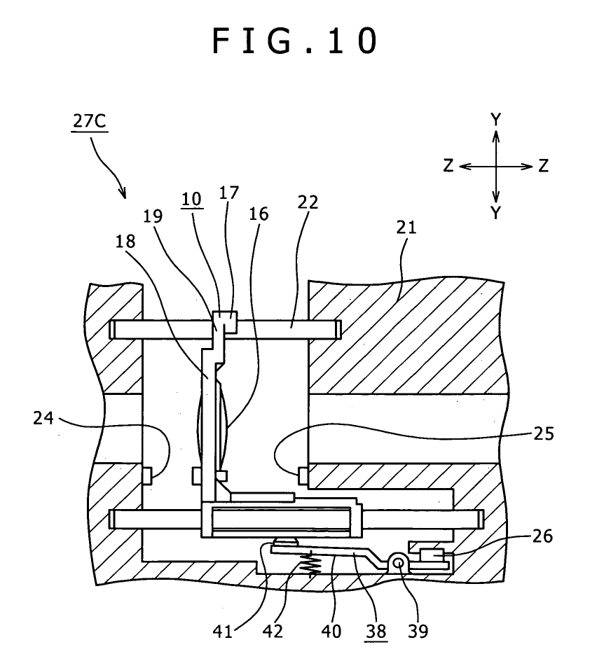

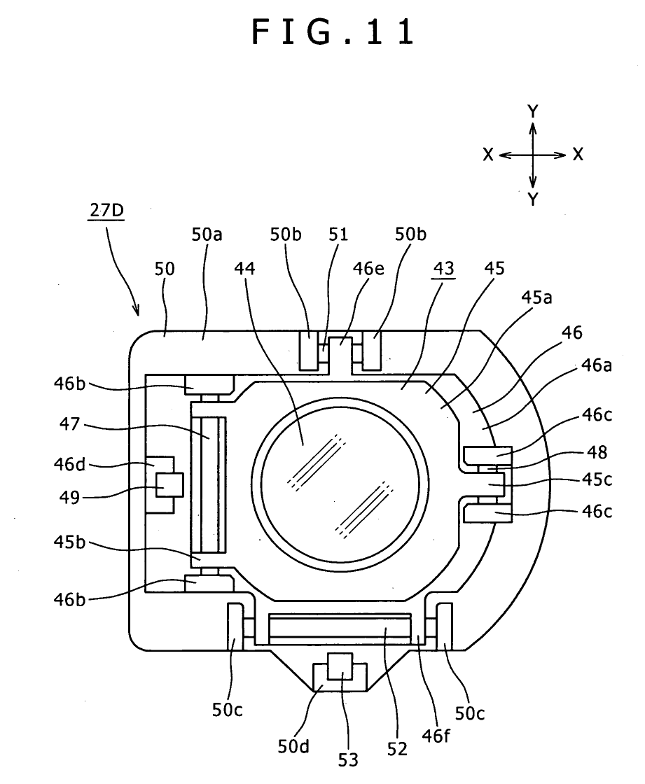

Next, a shifting mechanism 27C according to a third modification is described (See FIGS. 9 and 10). The shifting mechanism 27C according to the third modification is similar to the above shifting mechanism 27 only except that the shifting mechanism 27C has deformation scale-up means. Thus, different portions as compared with the above shifting mechanism 27 are only described in detail, and other portions are given the same reference numerals used for similar portions in the above shifting mechanism 27, and are not described.

The piezoelectric device 26 is placed with one end in its expansion/contraction direction secured to the lens barrel 21, and in a downwardly projecting position within the lens barrel 21.

Deformation scale-up means 38 is placed at the inside of the lens barrel 21, specifically, at a position below the driven unit 10, for instance. The deformation scale-up means 38 is composed of a pivotal support 39 provided on an inside bottom face of the lens barrel 21, and a deformation scaling-up portion 40 supported with the above pivotal support 39. The deformation scaling-up portion 40 is formed lengthwise in the approximately same direction as the direction of shifting of the driven unit 10, and its longitudinally intermediate portion is supported with the pivotal support 39 pivotally. A supporting point of pivotal motion of the deformation scaling-up portion 40 is located rearwards away from a longitudinal center. With the deformation scaling-up portion 40 supported with the pivotal support 39, the deformation scaling-up portion 40 is arranged to have a longer frontward portion than a rearward portion with the pivotal support 39 as a boundary. A front end of the deformation scaling-up portion 40 is fitted with a depressing member 41 made of the rubber or resin material in an upwardly projecting position, for instance.

An energizing spring 42 is supported in a position between the front end of the deformation scaling-up portion 40 and the inside bottom face of the lens barrel 21. The energizing spring 42 is specified as a tensile coiled spring, for instance. Thus, the deformation scaling-up portion 40 is energized in a pivotal direction in which the front end of the deformation scaling-up portion is shifted downwards, while the piezoelectric device 26 is downwardly pressed into contact with the rear end of the deformation scaling-up portion 40 at all times.

In the shifting mechanism 27C having the above configuration, when the drive current is supplied to the driving coil of the linear actuator, the driven unit 10 may be shifted in the optical axis direction depending on the supplied drive current direction.

When the driven unit 10 reaches the prescribed position, the drive voltage is applied to the piezoelectric device 26, causing the rear end of the deformation scaling-up portion 40 to be pressed downwards by the above piezoelectric device 26, thus causing the deformation scaling-up portion 40 to be pivoted with the pivotal support 39 as a supporting point (See FIG. 10). Pivoting of the deformation scaling-up portion 40 brings the depressing member 41 into pressure contact with the second supported projection 20 of the driven unit 10 upwards, causing the shifting of the driven unit to be stopped. At this time, because of a form of the deformation scaling-up portion 40 having the longer frontward portion than the rearward portion with the pivotal support 39 as the boundary, the extent of deformation (expansion) of the piezoelectric device 26 is increased, permitting the depressing member 41 to be shifted.

At the same time as the application of the drive voltage to the piezoelectric device 26, the supply of the drive current to the driving coil of the linear actuator is stopped.

When the piezoelectric device 26 causes the shifting of the driven unit 10 to be stopped, the application of the drive voltage to the piezoelectric device 26 is stopped. The piezoelectric device 26 is allowed to keep its expanded state for a certain period of time even after the application of the drive voltage to the piezoelectric device 26 is stopped, so that the stopped state of the driven unit 10 may be kept.

When the drive current is re-supplied to the driving coil of the linear actuator, the reverse drive voltage different in direction from the last applied drive voltage is applied to the piezoelectric device 26, causing the piezoelectric device 26 to be contracted into pivoting of the scaling-up portion 40 with an energizing force of the energizing spring 42 for bringing the depressing member 41 away from the second supported projection 20, thus causing the holding state against the driven unit 10 to be released. Accordingly, the re-supply of the drive current to the driving coil leads to the shifting of the driven unit 10 in the optical axis direction.

Sequentially, the application of the reverse drive voltage to the piezoelectric device 26 is stopped, in which case, however, the piezoelectric device 26 is allowed to keep its contracted state.

As described above, the shifting mechanism 27C ensures that an increase in deformation of the piezoelectric device 26 allows the depressing member 41 to be pressed into contact with the driven unit 10, permitting use of the piezoelectric device 26 limited in deformation to a small extent, thus resulting in reductions in size and manufacture cost of the shifting mechanism 27C in accordance with the use of the piezoelectric device limited in deformation.

Further, since the increase in deformation of the piezoelectric device 26 allows the depressing member 41 to be pressed into contact with the driven unit 10, the depressing member 41 may be surely held against the driven unit 10 regardless of accuracy for installation of the piezoelectric device 26 to the lens barrel 21.

Furthermore, use of the energizing spring 42 to energize the deformation scaling-up portion 40 in the prescribed pivotal direction as described above makes it possible to surely pivot the deformation scaling-up portion 40 in the above prescribed direction for releasing the limitation in the shifting of the driven unit 10, and also to prevent unnecessary pivoting of the deformation scaling-up portion 40.

Although the above shifting mechanisms 27, 27A, 27B and 27C have been described in relation to the shifting mechanism of a type that allows the driven unit 10 to be shifted with respect to two guide shafts, it is to be noted that the above shifting mechanisms may also take a different form that allows the driven unit 10 to be shifted in the optical axis direction as an integral part of one guide shaft. In this case, it is also allowable to control the shifting of the driven unit by bringing the piezoelectric device or the depressing member fitted to the piezoelectric device into contact with the driven unit or the above one guide shaft.

Next, one application of the shifting mechanism of the present invention to an anti-shake mechanism is described (See FIG. 11).

A shifting mechanism 27D has a driven unit 43. The driven unit 43 has a movable lens 44 to be shifted in two directions (X- and Y-directions shown in FIG. 11) orthogonal to the optical axis for anti-shaking to make corrections for a camera shake and an object shake, a lens holder 45 that holds the movable lens 44, and a support base 46 that supports the lens holder 45. The driven unit 43 is shifted with the drive force given from the non-illustrated linear actuator having the driving magnet and the driving coil.

The lens holder 45 is formed with an approximately annular-shaped holder body 45a, and first and second supported projections 45b and 45c made projecting from the holder body 45a in directions opposite to each other.

The lens holder 45 is supported with the support base 46 movably in the Y-direction. The support base 46 is formed with a base surface 46a, laterally spaced first and second shaft-mounting projections 46b and 46c respectively provided on the base surface 46a, a device mount 46d provided at a left end of the base surface 46a, and vertically spaced first and second bearings 46e and 46f respectively provided on the base surface 46a.

The first shaft-mounting projection 46b is fitted with a first guide shaft 47 extending in the Y-direction, while the second shaft-mounting projection 46c is fitted with a second guide shaft 48 extending in the Y-direction. The first guide shaft 47 is inserted into the first supported projection 45b of the lens holder 45, while the second guide shaft 48 is inserted into the second supported projection 45c of the lens holder 45. Thus, the lens holder 45 is supported with the support base 46 through the first and the second guide shafts 47 and 48 movably in the Y-direction.

The device mount 46d is fitted with a first piezoelectric device 49 in a projecting form extending toward the first supported projection 45b. The piezoelectric device 49 is the same as the above piezoelectric device 16, and thus may be expanded or contracted into deformation in the multi-layer direction by the application of the drive voltage thereto.

The support base 46 is supported with a fixed base 50 movably in the X-direction. The fixed base 50 is secured within the non-illustrated lens barrel, and is formed with a base surface 50a, vertically spaced first and second shaft-mounting projections 50b and 50c respectively provided on the base surface 50a, and a device mount 50d provided at a lower end of the base surface 50a.

The first shaft-mounting projection-50b is fitted with a first guide shaft 51 extending in the X-direction, while the second shaft-mounting projection 50c is fitted with a second guide shaft 52 extending in the X-direction. The first guide shaft 51 is inserted into the first bearing 46e of the support base 46, while the second guide shaft 52 is inserted into the second bearing 46f of the support base 46. Thus, the support base 46 is supported with the fixed base 50 through the first and the second guide shafts 51 and 52 movably in the X-direction. When the support base 46 is shifted in the X-direction with respect to the fixed base 50, the lens holder 45 and the movable lens 44 may be shifted in the X-direction as an integral part of the support base 46.

The device mount 50d is fitted with a second piezoelectric device 53 in a projecting form extending toward the second bearing 46f of the support base 46. The second piezoelectric device 53 is the same as the above piezoelectric device 16, and thus may be expanded or contracted into deformation in the multi-layer direction by the application of the drive voltage thereto.

In the shifting mechanism 27D having the above configuration, when the drive current is supplied to the driving coil of the linear actuator, the lens holder 45 may be shifted in the Y-direction with respect to the support base 46 depending on the supplied drive current direction, or alternatively, the support base 46 may be shifted in the X-direction with respect to the fixed base 50 as the integral part of the movable lens 44 and the lens holder 45.

When the lens holder 45 reaches the prescribed position, the drive voltage is applied to the first piezoelectric device 49 fitted to the support base 46, causing the first piezoelectric device 49 to be expanded into pressure contact with the first supported projection 45b of the lens holder 45, thus causing the shifting of the lens holder 45 to be stopped.

At the same time as the application of the drive voltage to the first piezoelectric device 49, the supply of the drive current to the driving coil of the linear actuator is stopped.

When the first piezoelectric device 49 causes the shifting of the lens holder 45 to be stopped, the application of the drive voltage to the first piezoelectric device 49 is stopped. The first piezoelectric device 49 is allowed to keep its expanded state for a certain period of time even after the application of the drive voltage to the first piezoelectric device 49 is stopped, so that the stopped state of the lens holder 45 may be kept.

When the drive current is re-supplied to the driving coil of the linear actuator, the reverse drive voltage different in direction from the last applied drive voltage is applied to the first piezoelectric device 49, causing the first piezoelectric device 49 to be contracted away from the first supported projection 45b, thus causing the holding state against the lens holder 45 to be released. Accordingly, the re-supply of the drive coil to the driving coil leads to the shifting of the lens holder 45 in the Y-direction.

Sequentially, the application of the reverse drive voltage to the first piezoelectric device 49 is stopped, in which case, however, the first piezoelectric device 49 is allowed to keep its contracted state.

On the other hand, when the support base 46 reaches the prescribed position, the drive voltage is applied to the second piezoelectric device 53 fitted to the fixed base 50, causing the second piezoelectric device 53 to be expanded into pressure contact with the second bearing 46f of the support base 46, thus causing the shifting of the support base 46 to be stopped.

At the same time as the application of the drive voltage to the second piezoelectric device 53, the supply of the drive current to the driving coil of the linear actuator is stopped.

When the second piezoelectric device 53 causes the shifting of the support base 46 to be stopped, the application of the drive voltage to the second piezoelectric device 53 is stopped. The second piezoelectric device 53 is allowed to keep its expanded state for a certain period of time even after the application of the drive voltage to the second piezoelectric device 53 is stopped, so that the stopped state of the support base 46 may be kept.

When the drive current is re-supplied to the driving coil of the linear actuator, the reverse drive voltage different in direction from the last applied drive voltage is applied to the second piezoelectric device 53, causing the second piezoelectric device 53 to be contracted away from the second bearing 46f of the support base 46, thus causing the holding state against the support base 46 to be released. Accordingly, the re-supply of the drive current to the driving coil leads to the shifting of the support base 46 in the X-direction.

Sequentially, the application of the reverse drive voltage to the second piezoelectric device 53 is stopped, in which case, however, the second piezoelectric device 53 is allowed to keep its contracted state.

The shifting mechanism 27D enables holding of the lens holder 45 and the support base 46 in prescribed positions to be performed in the state where energizing to the linear actuator is stopped and no continuous energizing to the first and the second piezoelectric devices 49 and 53 is required, permitting the reduction in consumption power to be attained.

Although the above has been described in relation to the shifting mechanism 27D of a type that allows the lens holder 45 or the support base 46 specified as the driven unit 43 to be shifted with respect to the guide shafts 47 and 48 or 51 and 52, it is to be noted that the above shifting mechanism may also take a different form that allows the lens holder 45 and the support base 46 to be shifted in the X- and Y-directions as the integral part of the guide shafts 47 and 48 or 51 and 52. In this case, it is also allowable to control the shifting of the lens holder 45 and the support base 46 by bringing the piezoelectric device or the depressing member fitted to the piezoelectric device into contact with the lens holder 45 and the support base 46 or the guide shafts.

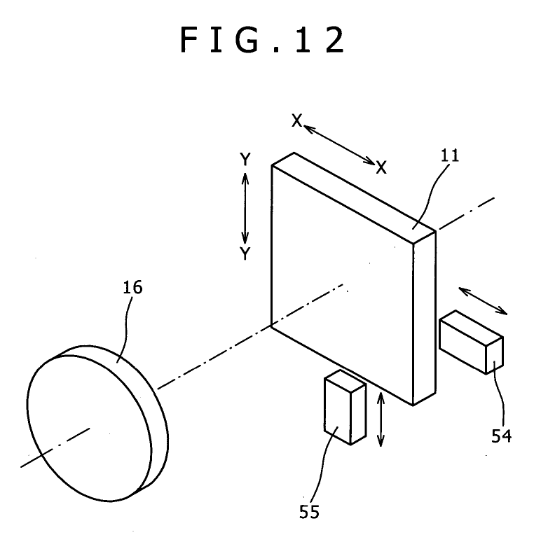

Although the above has been described in relation to one embodiment that is adapted to control the shifting of the driven unit 43 (the lens holder 45 and the support base 46) using two devices, the first and the second piezoelectric devices 49 and 53, it is also allowable to control the shifting of the imaging device 11 using first and second piezoelectric devices 54 and 55 as shown in FIG. 12, even when the anti-shake mechanism takes a different form that allows the imaging device 11, instead of the movable lens 44, to be shifted in directions orthogonal to the optical axis for anti-shaking.

It is to be noted that the above-described directions such as upwards, downwards, leftwards and rightwards are for the purpose of description and not of limitation in application of the present invention.

Any of the specific forms and structures of the units shown in the above preferred embodiments is only for the purpose of illustrating some embodiments in carrying out the present invention, and it is to be understood that the technical scope of the present invention is construed without being limited by any of the above forms and structures.

It should be understood by those skilled in the art that various modifications, combinations, sub-combinations and alterations may occur depending on design requirements and other factors insofar as they are within the scope of the appended claims or the equivalents thereof.

What is claimed is:

1. A shifting mechanism involving use of a linear actuator having a driving magnet and a driving coil as drive means for shifting a driven unit, or a movable lens contained in the driven unit, or an imaging device in a prescribed direction, comprising:
a piezoelectric device deformable with a drive voltage applied thereto and adapted to control shifting of the driven unit at the time when the piezoelectric device is deformed.

2. The shifting mechanism according to claim 1, wherein:
the driven unit is shifted in mutually perpendicular first and second directions respectively orthogonal to an optical axis direction of an optical imaging system including the movable lens and the imaging device, and the shifting mechanism is provided with a first piezoelectric device adapted to control shifting of the driven unit in the first direction, and a second piezoelectric device adapted to control shifting of the driven unit in the second direction.

3. The shifting mechanism according to claim 1, wherein:
the piezoelectric device has one end in the form of a fixed end, and the other end in the form of a free end, and
contact of the free end with the driven unit controls the shifting of the driven unit at the time when the piezoelectric device is deformed.

4. The shifting mechanism according to claim 2, wherein:
the piezoelectric device has one end in the form of a fixed end, and the other end in the form of a free end, and
contact of the free end with the driven unit controls the shifting of the driven unit at the time when the piezoelectric device is deformed.

5. The shifting mechanism according to claim 1, further comprising deformation scale-up means for increasing an extent of deformation of the piezoelectric device, wherein:
the piezoelectric device is placed at a side of one end of the deformation scale-up means, and
contact of the other end of the deformation scale-up means with the driven unit controls the shifting of the driven unit at the time when the piezoelectric device is deformed.

6. The shifting mechanism according to claim 2, further comprising deformation scale-up means for increasing an extent of deformation of the piezoelectric device, wherein:
the piezoelectric device is placed at a side of one end of the deformation scale-up means, and
contact of the other end of the deformation scale-up means with the driven unit controls the shifting of the driven unit at the time when the piezoelectric device is deformed.

7. The shifting mechanism according to claim 1, further comprising an energizing spring for applying an energizing force to the piezoelectric device in a direction to remove limitation on the shifting of the driven unit.

8. The shifting mechanism according to claim 2, further comprising an energizing spring for applying an energizing force to the piezoelectric device in a direction to remove limitation on the shifting of the driven unit.

9. An image capturing apparatus having a shifting mechanism involving use of a linear actuator having a driving magnet and a driving coil as drive means for shifting a driven unit, or a movable lens contained in the driven unit, or an imaging device in a prescribed direction, comprising:
a piezoelectric device deformable with a drive voltage applied thereto, and adapted to control shifting of the driven unit at the time when the piezoelectric device is deformed.
